(19) United States
(12) Patent Application Publication
(10) Pub. No.: US 2026/0318667 A1
(43) Pub. Date: Oct. 15, 2026

(54) INDUCTIVE POSITION SENSOR WITH C-SHAPED RECEIVE COILS AND CENTER CIRCUIT

(71) Applicant: SENSATA TECHNOLOGIES, INC., ATTLEBORO, MA (US)

(72) Inventor: JAMES M. MALOOF, WESTWOOD, MA (US)

(21) Appl. No.: 19/476,296

(22) PCT Filed: Apr. 2, 2024
(86) PCT No.: PCT/US2024/022595

§ 371 Date: Oct. 17, 2025

Related U.S. Application Data
(60) Provisional application No. 63/497,081, filed on Apr. 19, 2023.

(51) Int. Cl. G01B 7/00; G01D 5/20

(52) U.S. Cl. CPC G01B 7/003; G01B 7/001; G01D 5/2006

(57) ABSTRACT

Embodiments in accordance with the present disclosure are directed to apparatuses, systems, and methods for utilizing an inductive position sensor. In a particular embodiment, an inductive position sensor apparatus is disclosed that includes a sense element having an inner diameter and an outer diameter. In this example embodiment, the sense element comprises at least one transmit coil, a first c-shaped receive coil that includes a first plurality of arrayed loops, and a second c-shaped receive coil that includes a second plurality of arrayed loops. The inductive position sensor apparatus also includes a printed circuit board having an interface within the inner diameter of the sense element in which the interface is configured for coupling with an integrated circuit.

### BACKGROUND

Inductive position sensors provide feedback to the control systems for electric motors. For synchronous motors, this feedback is required in order to calculate the phase currents necessary to obtain the desired torque and achieve maximum motor efficiency.

Inductive position sensors operate on two core principles: induction of electromotive force (EMF) in a wire loop and induction of eddy currents in conductive materials. EMF is induced by changing the magnetic flux through a wire loop. This can be done by either changing the area of the loop within the magnetic field or by changing the strength of the field. Eddy currents are induced by either placing a conductor in a changing magnetic field or by relative motion between a conductor and a magnetic field.

In some inductive position sensors, a receive coil is 360 degrees or arc shaped with the ASIC circuitry outside of the outer diameter of the sense element.

### SUMMARY

Embodiments in accordance with the present disclosure are directed to apparatuses, systems, and methods for utilizing an inductive position sensor. In some examples, an inductive position sensor utilizes c-shaped receive coils and contains the ASIC circuitry within the inner diameter of the sense element.

In a particular embodiment, an inductive position sensor apparatus is disclosed that includes a sense element having an inner diameter and an outer diameter. In this example embodiment, the sense element comprises at least one transmit coil, a first c-shaped receive coil that includes a first plurality of arrayed loops, and a second c-shaped receive coil that includes a second plurality of arrayed loops. The inductive position sensor apparatus also includes a printed circuit board having an interface within the inner diameter of the sense element in which the interface is configured for coupling with an integrated circuit.

In another embodiment, a method for operating an inductive position sensor is disclosed. The method includes providing a sense element of an inductive position sensor. In this embodiment, the sense element has an inner diameter and an outer diameter and comprises at least one transmit coil, a first c-shaped receive coil that includes a first plurality of arrayed loops, and a second c-shaped receive coil that includes a second plurality of arrayed loops. The method also includes driving, by an integrated circuit of the inductive position sensor, a transmission signal to the at least one transmit coil, the integrated circuit within the inner diameter of the sense element. The method also includes monitoring, by the integrated circuit, a first reference signal in the first c-shaped receive coil and monitoring, by the integrated circuit, a second reference signal in the second c-shaped receive coil. The method also includes determining, by the integrated circuit, a position of a conductive target in proximity of the sense element based on one or more changes in the first reference signal and the second reference signal.

As will be explained further below, the c-shaped receive coil design with center circuitry decreases the size of the PCB and resulting epoxy volume required to cover the PCB, which decreases cost while maintaining performance.

These and other features, aspects, and advantages of the present disclosure will become better understood when the following detailed description is read with reference to the accompanying drawings in which like characters represent like parts throughout the drawings.

### BRIEF DESCRIPTION OF THE DRAWINGS

FIG. 1A illustrates an example inductive position sensor in accordance with at least one embodiment of the present disclosure.

FIG. 1B illustrates an example inductive position sensor in accordance with at least one embodiment of the present disclosure.

FIG. 2 is a flowchart illustrating an example method for utilizing an inductive position sensor in accordance with at least one embodiment of the present disclosure.

FIG. 3 is a flowchart illustrating an example method for utilizing an inductive position sensor in accordance with at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

A sensing element, which is directly connected to an integrated circuit (e.g., an application specific integrated circuit (ASIC)) includes a transmit coil and two c-shaped receive coils. According to embodiments of the present disclosure, the integrated circuit is positioned within the inner diameter of the sense element. Positing the integrated circuit within the inner diameter of the sense element having c-shaped receive coils reduces the size of the printed circuit board and therefore costs while retaining accuracy over prior designs in which the receive coils are either 360 degrees or arc shaped with the integrated circuit outside of the outer diameter of the sense element.

The transmit coil generates a magnetic field that is received by the receive coils. Driven by the integrated circuit, and in parallel with a capacitor, the transmit coil acts as a LC oscillator circuit. The LC oscillator generates a magnetic field that is the transmitted signal to the receive coils. The polarity of the magnetic field is determined by the direction of the current in the loop. The two receive coils are wire loops, connected to the integrated circuit, that exist within the oscillating magnetic field generated by the transmit coil. The field induces current flow in the coils and an EMF proportional to the area of the magnetic field within each of the wire loops.

The design of each receive coil creates multiple wire loops in the coil that have opposing EMF generation. Depending on the presence of the target, the EMF generated is translated into a voltage signal. This voltage signal is the input to the integrated circuit. Each coil is designed with a specified target to provide a sinusoidal change in voltage as the target moves from one point over the position sensor to another. In some embodiments, the target is a conductive material that interacts with the magnetic field generated by the transmit coil. When placed above the coil, the field induces eddy currents within the conductive target. The eddy currents then generate a second magnetic field which, according to Lenz's Law, opposes the initial magnetic field that interacted with the target. The result is an attenuated magnetic field in the area below (near) the target. The sensing element and the conductive target together generate a position signal. With the target present over a given wire loop, the attenuated magnetic field results in a change in the EMF generation for the effected loop. The delta is used to track the position of the target. To accomplish this, in some examples two receive coils are identical and phase shifted by 90°. This results in a sine and a cosine output of which the arctan can be taken to calculate the position of the target.

Inductive position sensors can include either linear (X, Y, Z) or angular (θ,R,Z) sensors. Angular sensors may be implemented as 360° sensors or arc sensors. As used herein, “phase blended” may refer to angularly arrayed coil coils in 360° sensors or arc sensors, or X-arrayed coils in a linear sensor. As used herein, “radially displaced” or “radially segmented” loops may refer to coil loops of a single coil that are located in different radial positions or zones along an R dimension in 360° sensors or arc sensors, or coil loops that are located different positions or zones along a Y dimension in a linear sensor. Multiple receive coils may be arrayed in the X or θ dimensions by less than a full electrical cycle with the optimal phase separation values being dependent on the number of receive coils and signal transform method (i.e., 2 or 3 phase sinusoids).

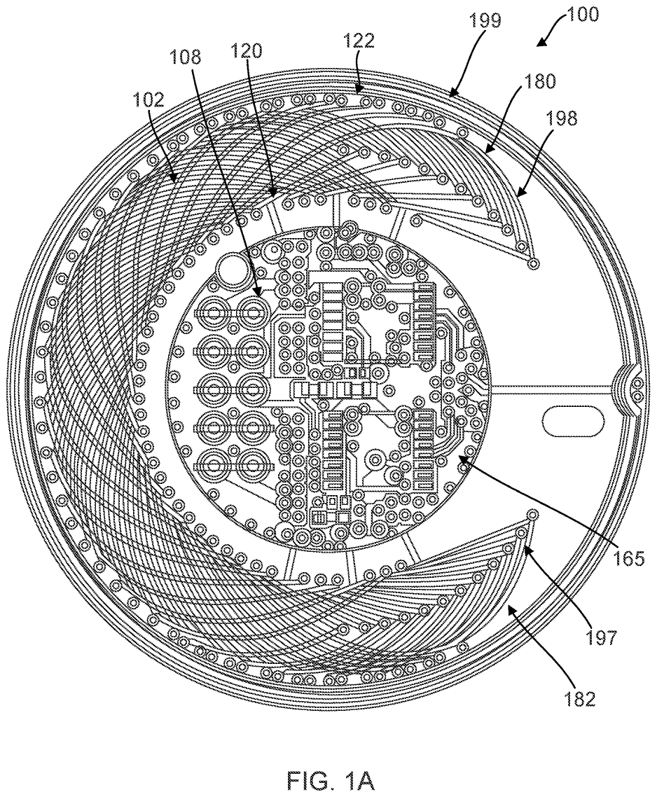

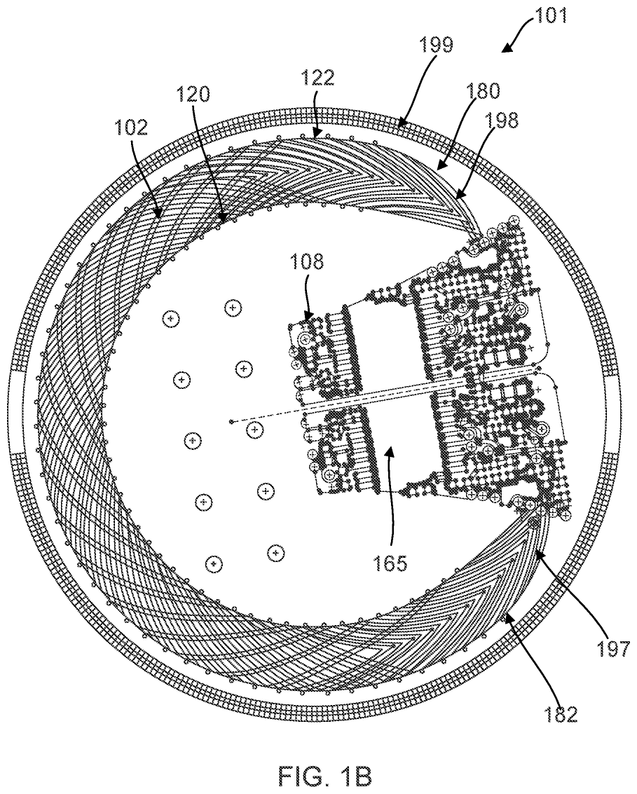

Exemplary apparatuses and methods for an inductive position sensor in accordance with the present disclosure are described with reference to the accompanying drawings, beginning with FIG. 1A. FIG. 1A sets forth an example inductive position sensor 100 that includes a sense element 102 having an inner diameter 120 and an outer diameter 122. FIG. 1B sets forth an example inductive position sensor 101 that includes a sense element 102 having an inner diameter 120 and an outer diameter 122. The sense element 102 includes at least one transmit coil 199, a first c-shaped receive coil 198 that includes a first plurality of arrayed loops, and a second c-shaped receive coil 197 that includes a second plurality of arrayed loops. Each of the inductive position sensors also include an integrated circuit 108 within the inner diameter 120 of the sense element 102. In the example of FIGS. 1A and 1B, the integrated circuit 108 is coupled to an interface of printed circuit board 165. In contrast to prior designs in which the receive coils are either 360 degrees or arc shaped with the integrated circuit outside of the outer diameter of the sense element, positing the integrated circuit within the inner diameter of the sense element having c-shaped receive coils reduces the size of the printed circuit board and therefore costs while retaining accuracy.

In a particular embodiment, the coil patterns of the first receive coil 198 and the second receive coil 197 are angularly arrayed, where the first receive coil 198 and the second receive signal coil 197 are themselves angularly arrayed with respect to each other. The coil layout includes sets of trace segments that correspond to portions of sinusoidal patterns. For example, some trace segments corresponds to a portion of a first sinusoidal pattern (e.g., sine) of a first signal, another trace segment corresponds to a portion of a first sinusoidal pattern (e.g., cosine) of a second signal, other trace segment corresponds to a portion of a second sinusoidal pattern (e.g., phase-shifted sine) of the first signal that is phase-shifted with respect to the first sinusoidal pattern of the first signal, and another trace segment corresponds to a portion of a second sinusoidal pattern (e.g., phase-shifted cosine) of the second signal that is phase-shifted with respect to the first sinusoidal pattern of the second signal. In the examples of FIGS. 1A-1B, an adjacent set of trace segments follow a reverse direction of the signal patterns respectively corresponding to another set of trace segments. Forward direction sets of trace segments alternate with reverse direction sets of other trace segments around the sensor in that each sinusoidal pattern loops around the sensor before reversing direction to form a reflection of the forward direction pattern. Each sinusoidal pattern may reverse direction at a natural junction point (e.g., where the current in the signal reverses). In these examples, the sinusoidal patterns (e.g., sine, cosine, phase-shifted sine, phase-shift cosine) reverse direction at via pairs. Similarly, initial signal patterns (e.g., sine and cosine) transition to phase-shifted signal patterns (e.g., phase-shift sine and phase-shifted cosine) at other via pairs.

In a particular embodiment, the coil layouts may occupy opposite sides of the PCB 165, such that trace segments on one layer of the PCB connect to trace segments in the coil layout on the other layer of the PCB through vias between the layers. To minimize crossovers between signals and phases of signals, trace segments corresponding to portions of the sinusoidal pattern with increasing amplitude may be disposed on one layer and trace segments corresponding to portions of the sinusoidal pattern with decreasing amplitude may be disposed on a different layer, with pass through vias connecting the increasing portions to the decreasing portions. The trace segments form four sinusoidal patterns that loop around the sensor for a two-signal sense element. In such a configuration, two phases of each signal are blended to improve the signal to noise ratio (SNR). The arctan of the sine and cosine receive signals may be calculated to determine the position of a target over the sense element.

In the example of FIGS. 1A-1B, each individual loop of each receive coil may be spaced offset from one another. In this example, the termination point of each loop in the first receive coil 198 is spaced apart by a particular degree, and the termination point of each loop in the second receive coil is spaced apart by the same degree. This configuration allows each loop of each coil to occupy a particular angular range and each coil to occupy another angular range. In the example of FIGS. 1A and 1B, some portion 180 of the first receive coil 198 hangs over the second receive coil 197 on one side and some portion 182 of the second receive coil 197 hangs over the first receive coil 198 on the other side creating a total angular range of the layout. Readers of skill in the art will realize that different spacing options between the coil loops may be better or worse for different applications depending on the size of the sensor, number of PCB layers, manufacturing capabilities, etc.

In the example of FIGS. 1A and 1B, the integrated circuit 108 is configured to drive high frequency AC current in the transmitter coil 199, generating an alternating magnetic field. In this example, the magnetic field induces voltages in the first receiver coil 198 and the second receiver coil 197. When a metal target is placed above the coils, the magnetic field from the transmitter coil induces eddy current in a surface of the metal target. The eddy currents of the metal target generate a counter magnetic field which reduces the flux density underneath the metal target. The non-uniform flux density beneath the metal target generates a voltage at the receiver coil terminals. In this configuration, as the target position changes, the amplitude and polarity of the voltages at the receive coils change. The integrated circuit is further configured to process the voltages monitored at the receive coils to output a signal indicative of the position of the metal target. If a target is not present at the receive coils, the serial connection of the alternating inverted/non-inverted coil loop segments provides zero output voltage.

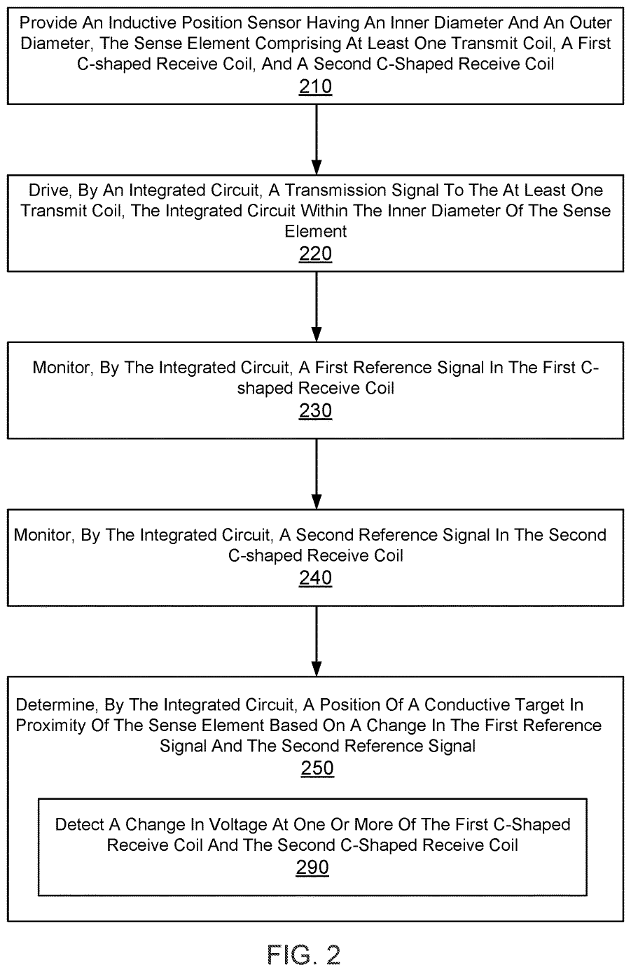

For further explanation, FIG. 2 sets forth a flow chart illustrating an example method for utilizing an inductive position sensor in accordance with an embodiment of the present disclosure. The method of FIG. 2 includes providing 210 a sense element comprising at least one transmit coil; a first c-shaped receive coil that includes a first plurality of arrayed loops; a second c-shaped receive coil that includes a second plurality of arrayed loops.

The example method of FIG. 2 also includes an integrated circuit (e.g., ASIC) of the inductive position sensor driving 220 the at least one transmit coil. In some examples, driving 220 the at least one transit coil includes driving the at least one transmit coil with a signal in parallel with a capacitor to generate a magnetic field that is the transmitted signal to the receive coils. In the example of FIG. 2, the integrated circuit is positioned within an inner diameter of the sense element.

The example method of FIG. 2 also includes monitoring 230 a first reference signal in the first c-shaped receive coil and monitoring 240 a second reference signal in the second c-shaped receive coil. In some examples, monitoring 230 a first reference signal in the first c-shaped receive coil and monitoring 240 a second reference signal in the second c-shaped receive coil is carried out by an integrated circuit that detects the voltage in the first receive coil and the second receive coil induced by the magnetic field generated by the signal transmitted by the transmit coil. In a particular embodiment, the integrated circuit may store values for the monitored voltages.

The example method of FIG. 2 also includes determining 250 a position of a conductive target in proximity of the sense element based on a change in the first reference signal and the second reference signal. In some examples, determining 250 a position of a conductive target in proximity of the sense element based on a change in the first reference signal and the second reference signal includes the integrated circuit detecting 290 a change in voltage at one or more of the first c-shaped receive coil and the second c-shaped receive coil. Detecting 290 a change in voltage at one or more of the first c-shaped receive coil and the second c-shaped receive coil may be carried out by calculating the arctan of the sine and cosine outputs of the outputs from the receive coils.

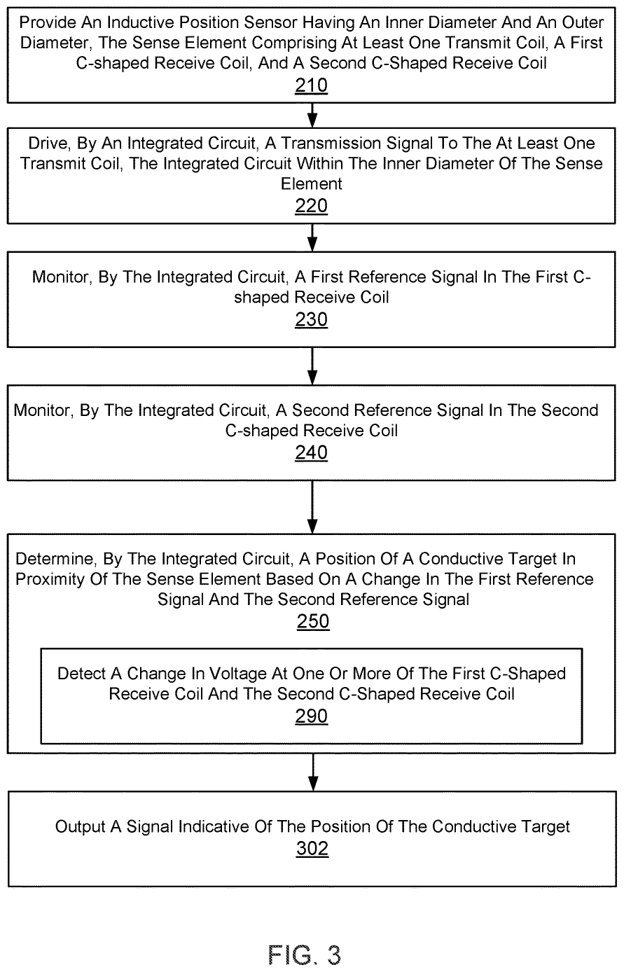

For further explanation, FIG. 3 sets forth a flow chart illustrating an example method for utilizing an inductive position sensor in accordance with an embodiment of the present disclosure. The method of FIG. 3 includes providing 210 a sense element; driving 220 the at least one transmit coil; monitoring 230 a first reference signal in the first c-shaped receive coil; monitoring 240 a second reference signal in the second c-shaped receive coil; and determining 250 a position of a conductive target in proximity of the sense element based on a change in the first reference signal and the second reference signal.

In addition, the method of FIG. 3 also includes outputting 302, by the integrated circuit, a signal indicative of the position of the conductive target. Outputting 302, by the integrated circuit, a signal indicative of the position of the conductive target may be carried out changing a signal frequency, signal pattern, or voltage level on a line leading out of the integrated circuit. In this example, different frequencies, signal patterns, or voltage levels may correspond to different positions for the conductive target.

In view of the foregoing, it will be appreciated that an inductive position sensor in accordance with the present disclosure provides a number of advantages, including but not limited to reducing the space required for a PCB by positioning the integrated circuit within the inner diameter of the sense element.

Advantages and features of the present disclosure can be further described by the following statements:
1. An inductive position sensor apparatus comprising: a sense element having an inner diameter and an outer diameter, the sense element comprising: at least one transmit coil; a first c-shaped receive coil that includes a first plurality of arrayed loops; and a second c-shaped receive coil that includes a second plurality of arrayed loops; and a printed circuit board having an interface within the inner diameter of the sense element, the interface for coupling with an integrated circuit.
2. The inductive position sensor apparatus of statement 1 further comprising the integrated circuit coupled to the interface, the integrated circuit having at least some portion within the inner diameter of the sense element.
3. The inductive position sensor apparatus of statements 1 or 2, wherein the integrated circuit is configured to: provide a transmission signal to the at least one transmit coil; monitor a first reference signal in the first c-shaped receive coil; monitor a second reference signal in the second c-shaped receive coil; and determine a position of a conductive target based on one or more changes in the first reference signal and the second reference signal.
4. The inductive position sensor apparatus of any of statements 1-3, wherein determining the position of the conductive target based on the one or more changes in the first reference signal and the second reference signal includes detecting a change in voltage at one or more of the first c-shaped receive coil and the second c-shaped receive coil.
5. The inductive position sensor apparatus of any of statements 1-4, wherein the integrated circuit is further configured to output a signal indicative of the position of the conductive target.
6. The inductive position sensor apparatus of any of statements 1-5, wherein the at least one transmit coil surrounds the first c-shaped receive coil and the second c-shaped receive coil.
7. The inductive position sensor apparatus of any of statements 1-6, wherein one or more first outputs from the first c-shaped receive coil and one or more second outputs from the second c-shaped receive coil are within the inner diameter and connect to the integrated circuit.
8. The inductive position sensor apparatus of any of statements 1-7, wherein the at least one transmit coil creates a magnetic field in response to receiving the transmission signal.
9. The inductive position sensor apparatus of any of statements 1-8, wherein the first plurality of arrayed loops are phase-shifted.
10. The inductive position sensor apparatus of any of statements 1-9, wherein at least some portion of the first c-shaped receive coil overhangs the second c-shaped receive coil and at least some portion of the second c-shaped receive coil overhangs the first c-shaped receive coil.
11. The inductive position sensor apparatus of any of statements 1-10 further comprising a conductive target.
12. A method for operating an inductive position sensor, the method comprising: providing a sense element of an inductive position sensor, the sense element having an inner diameter and an outer diameter, the sense element comprising: at least one transmit coil; a first c-shaped receive coil that includes a first plurality of arrayed loops; and a second c-shaped receive coil that includes a second plurality of arrayed loops; driving, by an integrated circuit of the inductive position sensor, a transmission signal to the at least one transmit coil, the integrated circuit within the inner diameter of the sense element; monitoring, by the integrated circuit, a first reference signal in the first c-shaped receive coil; monitoring, by the integrated circuit, a second reference signal in the second c-shaped receive coil; and determining, by the integrated circuit, a position of a conductive target in proximity of the sense element based on one or more changes in the first reference signal and the second reference signal.
13. The method of statement 12, wherein determining, by the integrated circuit, a position of a conductive target in proximity of the sense element based on a change in the first reference signal and the second reference signal includes detecting a change in voltage at one or more of the first c-shaped receive coil and the second c-shaped receive coil.
14. The method of statements 12 or 13, wherein the integrated circuit is further configured to output a signal indicative of the position of the conductive target.
15. The method of any of statements 12-14, wherein the at least one transmit coil surrounds the first c-shaped receive coil and the second c-shaped receive coil.
16. The method of any of statements 12-15, wherein one or more first outputs from the first c-shaped receive coil and one or more second outputs from the second c-shaped receive coil are within the inner diameter and connect to the integrated circuit.
17. The method of any of statements 12-16, wherein the at least one transmit coil creates a magnetic field in response to receiving the transmission signal.
18. The method of any of statements 12-17, wherein the first plurality of arrayed loops are phase-shifted.
19. The method of any of statements 12-18, wherein at least some portion of the first c-shaped receive coil overhangs the second c-shaped receive coil and at least some portion of the second c-shaped receive coil overhangs the first c-shaped receive coil.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An inductive position sensor apparatus comprising:
a sense element having an inner diameter and an outer diameter, the sense element comprising:
at least one transmit coil;
a first c-shaped receive coil that includes a first plurality of arrayed loops; and
a second c-shaped receive coil that includes a second plurality of arrayed loops; and
a printed circuit board having an interface within the inner diameter of the sense element, the interface for coupling with an integrated circuit.

2. The inductive position sensor apparatus of claim 1 further comprising the integrated circuit coupled to the interface, the integrated circuit having at least some portion within the inner diameter of the sense element.

3. The inductive position sensor apparatus of claim 2, wherein the integrated circuit is configured to:
provide a transmission signal to the at least one transmit coil;
monitor a first reference signal in the first c-shaped receive coil;
monitor a second reference signal in the second c-shaped receive coil; and
determine a position of a conductive target based on one or more changes in the first reference signal and the second reference signal.

4. The inductive position sensor apparatus of claim 3, wherein determining the position of the conductive target based on the one or more changes in the first reference signal and the second reference signal includes detecting a change in voltage at one or more of the first c-shaped receive coil and the second c-shaped receive coil.

5. The inductive position sensor apparatus of claim 3, wherein the integrated circuit is further configured to output a signal indicative of the position of the conductive target.

6. The inductive position sensor apparatus of claim 1, wherein the at least one transmit coil surrounds the first c-shaped receive coil and the second c-shaped receive coil.

7. The inductive position sensor apparatus of claim 2, wherein one or more first outputs from the first c-shaped receive coil and one or more second outputs from the second c-shaped receive coil are within the inner diameter and connect to the integrated circuit.

8. The inductive position sensor apparatus of claim 3, wherein the at least one transmit coil creates a magnetic field in response to receiving the transmission signal.

9. The inductive position sensor apparatus of claim 2, wherein the first plurality of arrayed loops are phase-shifted.

10. The inductive position sensor apparatus of claim 1, wherein at least some portion of the first c-shaped receive coil overhangs the second c-shaped receive coil and at least some portion of the second c-shaped receive coil overhangs the first c-shaped receive coil.

11. The inductive position sensor apparatus of claim 1 further comprising a conductive target.

12. A method for operating an inductive position sensor, the method comprising:
providing a sense element of the inductive position sensor, the sense element having an inner diameter and an outer diameter, the sense element comprising:
at least one transmit coil;
a first c-shaped receive coil that includes a first plurality of arrayed loops; and
a second c-shaped receive coil that includes a second plurality of arrayed loops;
driving, by an integrated circuit of the inductive position sensor, a transmission signal to the at least one transmit coil, the integrated circuit within the inner diameter of the sense element;
monitoring, by the integrated circuit, a first reference signal in the first c-shaped receive coil;
monitoring, by the integrated circuit, a second reference signal in the second c-shaped receive coil; and
determining, by the integrated circuit, a position of a conductive target in proximity of the sense element based on one or more changes in the first reference signal and the second reference signal.

13. The method of claim 12, wherein determining, by the integrated circuit, a position of a conductive target in proximity of the sense element based on a change in the first reference signal and the second reference signal includes detecting a change in voltage at one or more of the first c-shaped receive coil and the second c-shaped receive coil.

14. The method of claim 12 further comprising outputting, by the integrated circuit, a signal indicative of the position of the conductive target.

15. The method of claim 12, wherein the at least one transmit coil surrounds the first c-shaped receive coil and the second c-shaped receive coil.

16. The method of claim 12, wherein one or more first outputs from the first c-shaped receive coil and one or more second outputs from the second c-shaped receive coil are within the inner diameter and connect to the integrated circuit.

17. The method of claim 12, wherein the at least one transmit coil creates a magnetic field in response to receiving the transmission signal.

18. The method of claim 12, wherein the first plurality of arrayed loops are phase-shifted.

19. The method of claim 12, wherein at least some portion of the first c-shaped receive coil overhangs the second c-shaped receive coil and at least some portion of the second c-shaped receive coil overhangs the first c-shaped receive coil.
